(19) United States
(12) Patent Application Publication
(10) Pub. No.: US 2011/0123173 A1
(43) Pub. Date: May 26, 2011

(54) TRICK PLAY ADVERTISING SYSTEMS AND METHODS

(75) Inventors: Michael P. Ruffini, Methuen, MA (US); Harpal S. Bassali, San Francisco, CA (US)

(73) Assignee: VERIZON PATENT AND LICENSING INC., Basking Ridge, NJ (US)

(21) Appl. No.: 12/624,711

(22) Filed: Nov. 24, 2009

(51) Int. Cl. H04N 5/91; G06Q 30/00; H04N 7/00; H04N 9/80; H04N 5/783; G06F 3/048

(52) U.S. Cl. 386/249; 705/14.4; 715/720; 386/E05.001; 386/345; 386/347

(57) ABSTRACT

Exemplary trick play advertising systems and methods are described herein. An exemplary method includes a media content access system detecting a command to execute a trick play function on a media content program, accessing a splash screen advertisement in response to the detected command, and providing the splash screen advertisement for display during an execution of the trick play function. Corresponding methods and systems are also described.

### BACKGROUND INFORMATION

Set-top boxes and other media content access devices are often configured to provide users with access to a large number and variety of media content choices. For example, a user may choose to experience a variety of broadcast television programs, pay-per-view services, video-on-demand programming, Internet services, and audio programming via a set-top box.

Certain media content access devices include a digital video recording (“DVR”) application that allows a user to view or otherwise experience media content in one or more “trick play” modes. For example, a user may skip to a different position within a media content program, fast forward within a media content program, and/or rewind within a media content program.

DVR technology has had a significant impact on the advertising industry. In the past, the basic business model for broadcast television programming has been free or low cost distribution of media content, subsidized by the insertion of advertisements within a media content stream. However, DVR applications allow users to easily skip these advertisements. Hence, alternative approaches to distributing advertisements to DVR users are desirable.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary media content access system according to principles described herein.

FIG. 2 illustrates an exemplary implementation of the system of FIG. 1 according to principles described herein.

FIG. 3 illustrates exemplary components of a media content provider subsystem according to principles described herein.

FIG. 4 illustrates exemplary components of a media content access subsystem according to principles described herein.

FIG. 5 illustrates an exemplary media content access device having the media content access subsystem of FIG. 4 implemented thereon according to principles described herein.

FIG. 6 illustrates an exemplary remote control user input device according to principles described herein.

FIG. 7 illustrates an exemplary trick play advertising method according to principles described herein.

FIG. 8 illustrates a representation of an exemplary media content program according to principles described herein.

### DETAILED DESCRIPTION OF PREFERRED EMBODIMENTS

Exemplary trick play advertising systems and methods are described herein. As described in more detail below, one or more splash screen advertisements may be presented during execution of a trick play function. For example, a media content access system may detect a command to execute a trick play function on a media content program, access a splash screen advertisement in response to the detected command, and provide the splash screen advertisement for display during an execution of the trick play function. To illustrate, a media content access device may be playing back a media content program for experiencing by a user of the media content access device. A user of the device may want to skip a segment (e.g., a commercial segment) in the media content program. To this end, the user may provide an input command configured to initiate a trick play function for skipping content. The media content access device may detect the input command and respond by accessing and providing a splash screen advertisement for display during the execution of the trick play function.

As used herein, the term “media content” may refer generally to any content that may be accessed and/or presented by a media content access system for experiencing by a user of the media content access system. The term “media content program” as used herein may refer generally to any instance of media content that may be operated on by a trick play function, including any television program, on-demand media program, pay-per-view media program, broadcast media program (e.g., broadcast television program), multicast media program, narrowcast media program, IPTV program, video program, streamed media program, recorded live transmission of a media program, and any other form of media content that may be accessed, presented, and subjected to processing in a trick play mode by the media content access system.

As used herein, the term “trick play function” may refer generally to a function that operates on a media content program in a non-linear way. Execution of a trick play function may alter and/or interrupt a normal, linear playback of the media content program. Examples of trick play functions include, but are not limited to, skipping forward, skipping backward, fast-forwarding, and rewinding within a media content program in association with a playback of the media content program. In certain examples, execution of a trick play function in association with a playback of a media content program traverses a segment of the media content program at a rate that is faster than a normal playback rate. Accordingly, a user may initiate execution of trick play functions to skip over, fast-forward, and/or rewind content at rates that are faster than a rate at which the content is traversed during normal playback. Execution of a trick play function on a media content program may be referred to as processing of the media content program in a “trick play mode.”

As used herein, the term “splash screen advertisement” may refer to any advertisement that is configured to be displayed for viewing by a user during execution of a trick play function. A splash screen advertisement may include one or more images, banner ads, messages, and/or interactive options configured to facilitate user interaction with the splash screen advertisement. In some embodiments, a splash screen advertisement may include an audio component in addition to a visual component. Typically, a splash screen advertisement may be designed to attract the attention of a user when the splash screen advertisement is briefly displayed (e.g., for approximately one second of time in some embodiments) during execution of a trick play function.

Trick play advertising as described herein may be beneficial to advertisers and/or service providers who would prefer that users of media content access devices experience splash screen advertisements rather than skip over and miss commercial segments included in media content programs. In addition, trick play advertising may be beneficial to users of media content access devices. Rather than entirely missing skipped commercial segments, for example, splash screen advertisements, which may or may not be related to the skipped commercial segments, may be conveniently and quickly viewed by users during execution of trick play functions. In some examples, one or more tools configured to facilitate user access to additional advertising content related to one or more splash screen advertisements may be provided. According, a user who utilizes a trick play function to skip over a commercial segment may view a splash screen advertisement related to the commercial segment and realize that the skipped commercial segment is of interest to the user. The user may then access and view the commercial segment such as by rewinding back to and playing the commercial segment.

Exemplary trick play advertising systems and methods will now be described with reference to the accompanying drawings.

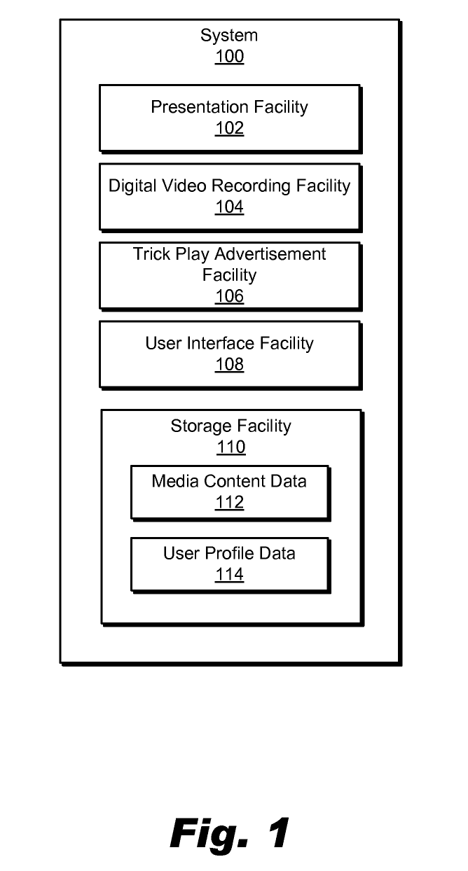

FIG. 1 illustrates an exemplary media content access system 100 (or simply “system 100”). As will be described in more detail below, system 100 may be configured to facilitate trick play advertising, including presenting one or more splash screen advertisements during execution of one or more trick play functions.

System 100 may include, without limitation, a presentation facility 102, a digital video recording (“DVR”) facility 104, a trick play advertisement facility 106, a user interface facility 108, and a storage facility 110 selectively and communicatively coupled to one another. Any suitable communication technologies, including any of the communication technologies mentioned herein, may be employed to facilitate communications between facilities 102-110. Each of these facilities will now be described in more detail.

Presentation facility 102 may be configured to present media content for experiencing by a user. A presentation of media content may be performed in any suitable way such as by generating and/or providing output signals representative of media content to a display device (e.g., a television) and/or an audio output device. For example, presentation facility 102 may display, play back, or otherwise present a media content program, an advertisement (e.g., a splash screen advertisement), or any other type of media content for experiencing by a user. Presentation facility 102 may present a media content program by playing back the media content program at a normal, linear playback rate such that a user may experience the media content program.

DVR facility 104 may be configured to facilitate temporary and/or permanent recording of selected media content to storage facility 110. For example, DVR facility 104 may record a live transmission of a media content program such as a broadcast or multicast television program. The media content program may be buffered and stored in media content data 112 in storage facility 110.

Presentation facility 102 and/or DVR facility 104 may be further configured to process media content in one or more trick play modes, which may include executing one or more trick play functions, such as any of the trick play functions mentioned herein, on a media content program. For example, presentation facility 102 and/or DVR facility 104 may be configured to receive and execute one or more trick play commands input by a user. An exemplary trick play command may be configured to cause presentation facility 102 and/or DVR facility 104 to execute a trick play function such as skipping from one position to another position within a media content program, fast forward within a media content program, and/or rewind within a media content program. The execution of a trick play function by presentation facility 102 and/or DVR facility 104 may begin when normal playback of a media content program is interrupted to begin execution of the trick play function and end when normal playback of the media content program is resumed after the trick play function has been executed. The trick play function may be executed by moving a play head that marks a playback position within a media content program. For example, the play head may be skipped forward or backward a predetermined length of time or moved forward or backward at a rate that is faster than a normal playback rate.

Trick play advertisement facility 106 may be configured to detect a command to execute a trick play function in association with a playback of a media content program, access a splash screen advertisement in response to the detected command, and provide the splash screen advertisement for display during the execution of the trick play function. Trick play advertisement facility 106 may interact with presentation facility 102, DVR facility 104, user interface facility 108, and/or storage facility 110 to detect a command to execute a trick play function in association with a playback of a media content program, access a splash screen advertisement in response to the detected command, and provide the splash screen advertisement for display during the execution of the trick play function. For example, trick play advertisement facility 106 may communicate with user interface facility 108 to detect a trick play command that has been input by a user and received by user interface facility 108. Additionally or alternatively, trick play advertisement facility 106 may communicate with presentation facility 102 and/or DVR facility 104 to detect a trick play command received or issued by presentation facility 102 and/or DVR facility 104. Trick play advertisement facility 106 may communicate with presentation facility 102, DVR facility 104, and/or storage facility 110 to access a splash screen advertisement. Trick play advertisement facility 106 may then communicate with presentation facility 102, DVR facility 104, and/or user interface facility 108 to provide the splash screen advertisement for display during execution of a trick play function. Examples of trick play advertising, which may be performed by trick play advertisement facility 106, are described in more detail further below.

User interface facility 108 may be configured to receive user input and provide user output and may include any hardware, firmware, software, or combination thereof supportive of input and output capabilities. For example, user interface facility 108 may include one or more devices for capturing user input, including, but not limited to, a microphone, speech recognition technologies, keyboard or keypad, receiver (e.g., an RF or infrared receiver), and one or more input buttons. User interface facility 108 may additionally or alternatively include one or more devices for presenting output to a user, including, but not limited to, a graphics engine, a display device (e.g., a display screen), one or more output drivers (e.g., display drivers), one or more audio speakers, and one or more audio drivers.

Storage facility 110 may be configured to maintain media content data 112 representing one or more media content programs accessible for playback by presentation facility 102. The media content programs may have been recorded to storage facility 110 by DVR facility 104 as described above and may be available to time-shifted playback by presentation facility 102 and/or DVR facility 104. Additionally or alternatively, media content data 112 may include any other media content programs that may be played back for experiencing by a user and processed in one or more trick play modes.

Storage facility 110 may also maintain user profile data 114, which may include data representative of a user profile associated with a user of system 100 and/or one or more media content access devices implementing system 100. User profile data 114 may include any information about the user, including user preferences and/or user configurable settings that may be used to identify and access splash screen advertisements, as described further below.

It will be recognized that storage facility 110 may maintain additional or alternative data as may serve a particular application. In certain embodiments, for example, storage facility 110 may include data representative of one or more splash screen advertisements.

System 100, including facilities 102-110, may include any computer hardware and/or computer-implemented instructions (e.g., software), or combinations of computer-implemented instructions and hardware, configured to perform one or more of the processes described herein. In particular, system 100 may be implemented on one physical computing device or may be implemented on more than one physical computing device. Accordingly, system 100 may include any number of computing devices, and may employ any of a number of computer operating systems. Moreover, it will be recognized that although facilities 102-110 are shown to be separate facilities in FIG. 1, any of those facilities may be combined into a single facility as may serve a particular application.

Accordingly, one or more of the processes described herein may be implemented at least in part as instructions executable by one or more computing devices. In general, a processor (e.g., a microprocessor) receives instructions, from a computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a floppy disk, flexible disk, hard disk, magnetic tape, any other magnetic medium, a CD-ROM, a DVD, any other optical medium, a RAM, a PROM, an EPROM, a FLASH-EEPROM, any other memory chip or cartridge, or any other medium from which a computer can read.

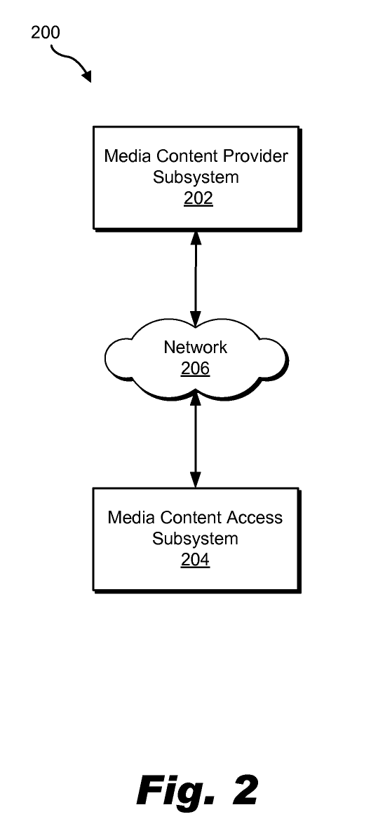

FIG. 2 illustrates an exemplary implementation 200 of system 100 wherein a media content provider subsystem 202 (or simply “provider subsystem 202”) is communicatively coupled to a media content access subsystem 204 (or simply “access subsystem 204”). As will be described in more detail below, presentation facility 102, DVR facility 104, trick play advertisement facility 106, user interface facility 108, and storage facility 110 may each be implemented on one or both of provider subsystem 202 and access subsystem 204.

Access subsystem 204 may be configured to communicate with and receive a signal and/or data stream containing data representative of media content and/or data associated with media content (e.g., metadata, program guide data, etc.) from provider subsystem 202. Access subsystem 204 and provider subsystem 202 may communicate using any suitable communication technologies, devices, networks, media, and protocols supportive of remote data communications.

For example, as shown in FIG. 2, provider subsystem 202 may be configured to communicate with access subsystem 204 over a network 206 (and communications links thereto). Network 206 may include one or more networks or types of networks capable of carrying communications and/or data signals between provider subsystem 202 and access subsystem 204. For example, network 206 may include, but is not limited to, a cable network, optical fiber network, hybrid fiber coax network, wireless network (e.g., a Wi-Fi and/or mobile telephone network), satellite network, wireless broadcast network (e.g., a satellite media broadcasting network or terrestrial broadcasting network), subscriber television network, a provider-specific network (e.g., a Verizon® FIOS® network), the Internet, an intranet, local area network, any other suitable network, and any combination or sub-combination of these networks.

Provider subsystem 202 and access subsystem 204 may communicate over network 206 using any suitable communication technologies, devices, media, and protocols supportive of remote data communications, including, but not limited to, data transmission media, communications devices, Transmission Control Protocol (“TCP”), Internet Protocol (“IP”), File Transfer Protocol (“FTP”), Telnet, Hypertext Transfer Protocol (“HTTP”), Real Time Protocol (“RTP”), User Datagram Protocol (“UDP”), Ethernet, and any other suitable communications technologies, devices, media, and protocols.

While FIG. 2 shows provider subsystem 202 and access subsystem 204 communicatively coupled via network 206, it will be recognized that provider subsystem 202 and access subsystem 204 may be configured to communicate one with another in any other suitable manner (e.g., via a direct connection).

In some examples, provider subsystem 202 may be configured to generate or otherwise provide media content to access subsystem 204. Access subsystem 204 may be configured to facilitate access by a user to media content received from provider subsystem 202. To this end, access subsystem 204 may present the media content for experiencing (e.g., viewing) by a user, record the media content, parse metadata and/or other data associated with the media content, etc.

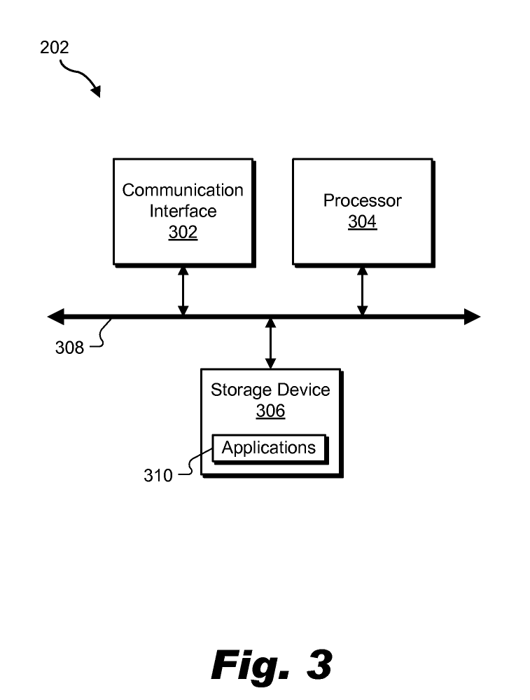

FIG. 3 illustrates exemplary components of provider subsystem 202. As shown in FIG. 3, provider subsystem 202 may include a communication interface 302, a processor 304, and a storage device 306 communicatively coupled one to another via a communication infrastructure 308. The components of provider subsystem 202 may communicate with one another, including sending data to and receiving data from one another, using any suitable communication technologies. Moreover, the components of provider subsystem 202 may be implemented on any computing device or combination of computing devices, such as one or more servers, personal computers, or the like.

While an exemplary provider subsystem 202 is shown in FIG. 3, the components illustrated in FIG. 3 are not intended to be limiting. Additional or alternative components may be used in other embodiments. Components of the provider subsystem 202 shown in FIG. 3 will now be described in additional detail.

Communication interface 302 may be configured to communicate with one or more computing devices, including access subsystem 204. In particular, communication interface 302 may be configured to transmit and/or receive communication signals, media content, and/or data to/from access subsystem 204. Examples of communication interface 302 include, without limitation, a wired network interface (such as a network interface card), a wireless network interface (such as a wireless network interface card), a modem, and any other suitable interface. In at least one embodiment, communication interface 302 may provide a direct connection between provider subsystem 202 and access subsystem 204 via a direct link to a network, such as the Internet. Communication interface 302 may additionally or alternatively provide such a connection through, for example, a local area network (such as an Ethernet network), a personal area network, a telephone or cable network, a cellular telephone connection, a satellite data connection, or any other suitable connection.

In some examples, communication interface 302 may be configured to transmit (e.g., broadcast, multicast, and/or narrowcast) data representative of one or more media content programs to access subsystem 204. Such data may be transmitted in one or more media content streams, as one or more data files, or in any other suitable manner as may serve a particular application. Communication interface 302 may be configured to interface with any suitable communication media, protocols, and formats, including any of those mentioned above.

Processor 304 generally represents any type or form of processing unit capable of processing data or interpreting, executing, and/or directing execution of one or more of the instructions, processes, and/or operations described herein. Processor 304 may direct execution of operations in accordance with one or more applications 310 or other computer-executable instructions such as may be stored in storage device 306 or another computer-readable medium. As an example, processor 304 may be configured to process data, including modulating, encoding, and/or otherwise preparing data (e.g., media content data) for transmission by communication interface 302.

Storage device 306 may include one or more data storage media, devices, or configurations and may employ any type, form, and combination of data storage media and/or device. For example, storage device 306 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 306. For example, data representative of one or more executable applications 310 configured to direct processor 304 to perform any of the operations described herein may be stored within storage device 306. In some examples, data may be arranged in one or more databases residing within storage device 306.

In some examples, presentation facility 102, DVR facility 104, trick play advertisement facility 106, user interface facility 108, and/or storage facility 110 may be implemented by or within one or more components of provider subsystem 202. For example, one or more applications 310 residing within storage device 306 may be configured to direct processor 304 to perform one or more processes or functions associated with presentation facility 102, DVR facility 104, trick play advertisement facility 106, and/or user interface facility 108. Likewise, storage facility 110 may be implemented by or within storage device 306. For example, media content data 112 and/or user profile data 114 may be stored within storage device 306.

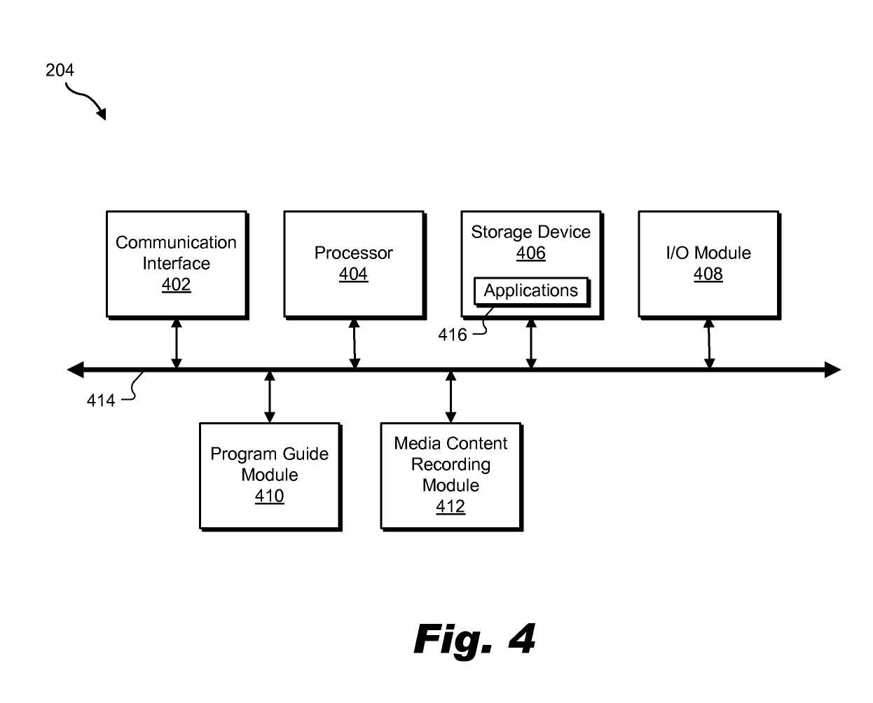

FIG. 4 illustrates exemplary components of access subsystem 204. As shown in FIG. 4, access subsystem 204 may include a communication interface 402, a processor 404, a storage device 406, an input/output (“I/O”) module 408, a program guide module 410, and a media content recording module 412 communicatively coupled one to another via a communication infrastructure 414. The components of access subsystem 204 may communicate with one another, including sending data to and receiving data from one another, using any suitable communication technologies. Moreover, the components of access subsystem 204 may be implemented on any computing device or combination of computing devices, such as a set-top box, a communications device, a mobile device (e.g., a mobile phone device), a handheld device, a personal computer, a phone device (e.g., Verizon Hub device), a personal-digital assistant device, gaming device, a DVR device, a television device, a media player device, and/or any media content access device configured to perform one or more of the processes and/or operations described herein.

While an exemplary access subsystem 204 is shown in FIG. 4, the components illustrated in FIG. 4 are not intended to be limiting. Additional or alternative components may be used in other embodiments. Components of the access subsystem 204 shown in FIG. 4 will now be described in additional detail.

Communication interface 402 may be configured to communicate with one or more computing devices, including provider subsystem 202. In particular, communication interface 402 may be configured to transmit and/or receive communication signals, media content, and/or data to/from provider subsystem 202. Examples of communication interface 402 include, without limitation, a wired network interface (such as a network interface card), a wireless network interface (such as a wireless network interface card), a modem, and any other suitable interface. In at least one embodiment, communication interface 402 may provide a direct connection between provider subsystem 202 and access subsystem 204 via a direct link to a network, such as the Internet. Communication interface 402 may additionally or alternatively provide such a connection through, for example, a local area network (such as an Ethernet network), a personal area network, a telephone or cable network, a cellular telephone connection, a satellite data connection, or any other suitable connection.

As mentioned, provider subsystem 202 may transmit (e.g., broadcast, multicast, and/or narrowcast) data representative of one or more media content programs. Communication interface 402 may be configured to receive such data such that the data may be processed by access subsystem 204. To this end, communication interface 402 may include any device, logic, and/or other technologies suitable for receiving signals, data streams, and/or data representative of media content. Communication interface 402 may be configured to interface with any suitable communication media, protocols, and formats, including any of those mentioned above.

In certain embodiments, provider subsystem 202 may be configured to transmit and access subsystem 204 may be configured to receive data streams or signals including data representative of various media content programs in accordance with a transmission schedule. The transmission schedule may specify that particular media content programs are to be transmitted at scheduled transmission times and on certain media content carrier channels. As used herein, the term “scheduled transmission time” or “scheduled transmission” may refer generally to any period of time during which a media content program is to be transmitted to access subsystem 204. The term “media content carrier channel” or simply “channel” as used herein may refer generally to any carrier of media content, including, but not limited to, media (e.g., television) channels, streams, addresses, frequencies or other carriers of media content.

Communication interface 402 may be configured to selectively identify, receive, and/or process appropriate data streams and/or media content programs at the scheduled transmission times and on the appropriate media content carrier channels. For instance, in certain implementations communication interface 402 may include a tuner configured to selectively receive media content carried on a particular media content carrier channel. The tuner may be tuned to a particular media content carrier channel such that the media content carried on the media content carrier channel is received and may be processed by access subsystem 204.

In some examples, communication interface 402 may include multiple tuners such that media content carried on different media content carrier channels may be concurrently received for processing by the access subsystem 204. For example, communication interface 402 may include a first tuner configured to receive media content carried on an analog video signal and a second tuner configured to concurrently receive media content carried on a digital compressed signal.

While one or more tuners may be used to receive various types of media content-carrying signals transmitted by provider subsystem 202, additionally or alternatively, communication interface 402 may be configured to receive other types of signals (e.g., other types of media content carrying signals) from provider subsystem 202 and/or one or more other sources without using a tuner. For example, provider subsystem 202 may transmit digital streams of data packets (e.g., Internet Protocol (“IP”) based data packets) that can be received without using a tuner. For such types of signals, communication interface 402 may receive and forward the signals directly to other components of access subsystem 204 without the signals going through a tuner. For an IP-based signal, for example, communication interface 402 may function as an IP receiver.

Processor 404 generally represents any type or form of processing unit capable of processing data or interpreting, executing, and/or directing execution of one or more of the instructions, processes, and/or operations described herein. Processor 404 may direct execution of operations in accordance with one or more applications 416 or other computer-executable instructions such as may be stored in storage device 406 or another computer-readable medium. As an example, processor 404 may be configured to process data, including demodulating, decoding, and/or parsing data (e.g., data representative of media content received from provider subsystem 202 by communication interface 402), and encoding and modulating data for transmission by communication interface 402.

Storage device 406 may include one or more data storage media, devices, or configurations and may employ any type, form, and combination of data storage media and/or device. For example, storage device 406 may include, but is not limited to, a hard drive, network drive, flash drive, magnetic disc, optical disc, RAM, DRAM, other non-volatile and/or volatile data storage units, or a combination or sub-combination thereof. Electronic data, including data described herein, may be temporarily and/or permanently stored in storage device 406. For example, data representative of one or more executable applications 416 configured to direct processor 404 to perform any of the operations described herein may be stored within storage device 406. In some examples, data may be arranged in one or more databases residing within storage device 406.

I/O module 408 may be configured to receive user input and provide user output and may include any hardware, firmware, software, or combination thereof supportive of input and output capabilities. For example, I/O module 408 may include one or more devices for capturing user input, including, but not limited to, a microphone, speech recognition technologies, keyboard or keypad, touch screen component (e.g., touch screen display), receiver (e.g., an RF or infrared receiver), and one or more input buttons.

I/O module 408 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 408 is configured to provide graphical data to a display for presentation to a user. The graphical data may be representative of one or more graphical user interfaces (“GUIs”), GUI views, media content views, splash screen advertisement views, and/or any other view as may serve a particular application.

Program guide module 410 may be configured to maintain and operate on program guide data. As mentioned above, media content programs may be transmitted by provider subsystem 202 at scheduled transmission times and on certain media content carrier channels. To assist access subsystem 204 and/or a user of access subsystem 204 with reception of media content programs at appropriate scheduled transmission times and on appropriate media content carrier channels, program guide data may be received by communication interface 402 from provider subsystem 202 and/or from another source. The program guide data may be stored in storage device 406.

Media content recording module 412 may be configured to record data representative of media content to storage device 406. The recording of a media content program is typically performed during a transmission time slot when data representative of the media content program is received from provider subsystem 202 as described above. For example, during transmission of a media content program from provider subsystem 202 to access subsystem 204 on a media content carrier channel, communication interface 402 may receive data representative of the media content program on the media content carrier channel, and media content recording module 412 may direct that the received data representative of the media content program be stored to storage device 406. Once stored, the data representative the media content program may be accessed and processed as may suit a particular application, including providing data representative of the media content program to a display for presentation to a user during playback of the media content program.

In some examples, presentation facility 102, DVR facility 104, trick play advertisement facility 106, user interface facility 108, and/or storage facility 110 may be implemented by or within one or more components of access subsystem 204. For example, one or more applications 416 residing within storage device 406 may be configured to direct processor 404 to perform one or more processes or functions associated with presentation facility 102, DVR facility 104, trick play advertisement facility 106, and/or user interface facility 108. Likewise, storage facility 110 may be implemented by or within storage device 406. For example, media content data 112 and/or user profile data 114 may be stored within storage device 406.

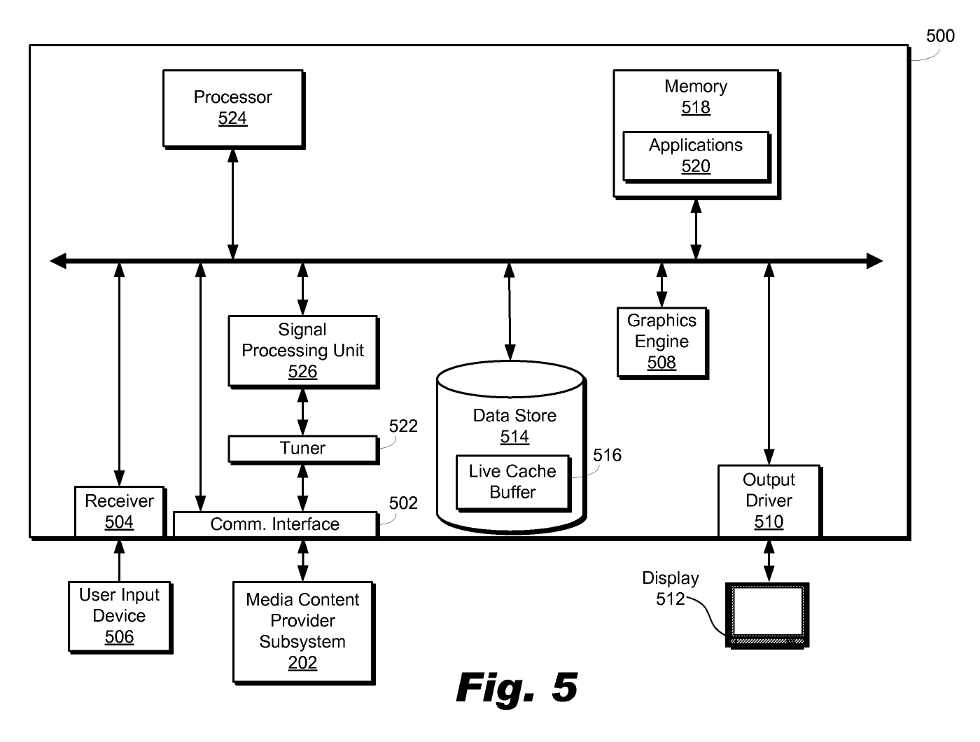

Access subsystem 204 and/or components of access subsystem 204 may be implemented as may suit a particular application. FIG. 5 illustrates an exemplary media content access device 500 (or simply “device 500”) having access subsystem 204 implemented thereon. Device 500 may include one or more of the components of access subsystem 204 shown in FIG. 4 and may be configured to perform one or more of the processes and/or operations described herein. Device 500 may include, but is not limited to, a set-top box, a media content processing device, a communications device, a mobile device (e.g., a mobile phone device), a handheld device, a personal computer, a phone device (e.g., Verizon Hub device), a personal-digital assistant device, a gaming device, a DVR device, a television device, a media player device, and/or any device configured to perform one or more of the processes and/or operations described herein.

As shown in FIG. 5, device 500 may include a communication interface 502 configured to receive media content (e.g., media content) and/or data (e.g., metadata, program guide data, and/or any other data associated with media content) in any acceptable format from provider subsystem 202 or from any other suitable external source. Communication interface 502 may include any device, logic, and/or other technologies suitable for receiving signals and/or data representative of media content and/or other types of media content or data. Communication interface 502 may be configured to interface with any suitable communication media, protocols, and formats, including any of those mentioned above.

Device 500 may also include a receiver 504 configured to receive user input signals from a user input device 506. User input device 506 may include, for example, a remote control device or any other suitable input device and may be configured to communicate with receiver 504 via a wireless link (e.g., by infrared signaling), electrical connection, or any other suitable communication link.

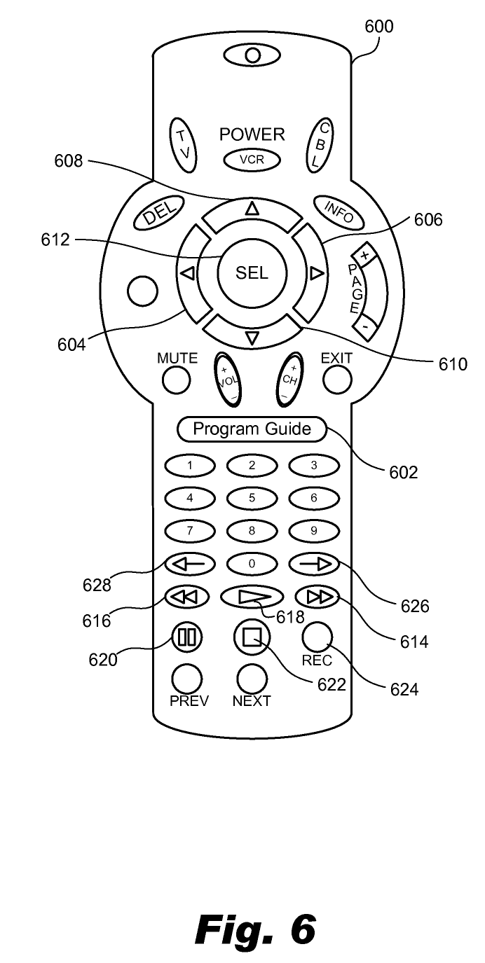

FIG. 6 illustrates an exemplary remote control device 600 that may implement user input device 506. In some examples, remote control device 600 may be configured to facilitate a user controlling operations of access subsystem 204. For instance, a program guide button 602 may be configured to evoke a presentation of a program guide GUI on a display. A left button 604, a right button 606, an up button 608, a down button 610, and a select button 612 may be included and configured to facilitate a user evoking and/or navigating through various views, options, and GUIs displayed by a display. A fast forward button 614, a rewind button 616, a play button 618, a pause button 620, a stop button 622, a record button 624, a skip forward button 626, and a skip backward button 628 may also be included and configured to facilitate a user navigating through, recording, playing, pausing, and/or otherwise interacting with one or more media content programs. Remote control device 600 is merely illustrative of one of the many different types of user input devices that may be used to provide input commands (e.g., trick play input commands) to access subsystem 204.

Returning to FIG. 5, device 500 may include a graphics engine 508 and an output driver 510. Graphics engine 508 may be configured to generate graphics to be provided to output driver 510, which may be configured to interface with or drive a display 512. Output driver 510 may provide output signals to display 512, the output signals including graphical content (e.g., media content, program guide media content, user interfaces, and/or splash screen advertisement views) generated by graphics engine 508 and to be presented by display 512 for experiencing by a user. Graphics engine 508 and output driver 510 may include any combination of hardware, software, and/or firmware as may serve a particular application.

Data store 514 may include one or more data storage media, devices, or configurations and may employ any type, form, and combination of storage media. For example, data store 514 may include, but is not limited to, a hard drive, network drive, flash drive, magnetic disc, optical disc, or other non-volatile storage unit. Media content and/or data associated with media content may be temporarily and/or permanently stored in data store 514.

Data store 514 is shown to be included within device 500 in FIG. 5 for illustrative purposes only. It will be understood that data store 514 may additionally or alternatively be located external to device 500.

Data store 514 may include one or more live cache buffers 516. Live cache buffer 516 may additionally or alternatively reside in memory 518 or in a storage device external to device 500. In some examples, media content data may be temporarily stored in live cache buffer 516 to facilitate recording of media content and/or presentation of media content in one or more trick play modes.

Device 500 may include memory 518. Memory 518 may include, but is not limited to, FLASH memory, RAM, DRAM, other suitable computer-readable media, or any combination or sub-combination thereof. In some examples, one or more applications 520 configured to run on or otherwise be executed by device 500 may reside in memory 518.

Device 500 may include one or more tuners 522. Tuner 522 may be configured to selectively receive media content carried on a particular media content carrier channel such that the media content may be processed by device 500. In some examples, media content received by tuner 522 may be temporarily buffered, or stored, in the live cache buffer 516. If there are multiple tuners 522, there may be a live cache buffer 516 corresponding to each of the tuners 522.

While tuner 522 may be used to receive certain media content-carrying signals transmitted by provider subsystem 202, device 500 may be configured to receive other types of content signals (including media content signals and/or program guide data signals) from provider subsystem 202 and/or one or more other sources without using a tuner. For example, provider subsystem 202 may transmit digital streams of data packets (e.g., Internet Protocol (“IP”) based data packets) that can be received without using a tuner. For such types of content signals, communication interface 502 may receive and forward the signals directly to other components of device 500 (e.g., processor 524 or signal processing unit 526, described in more detail below) without the signals going through tuner 522. For an IP-based signal, for example, signal processing unit 526 may function as an IP receiver.

Device 500 may include at least one processor, such as processor 524, configured to control and/or perform one or more operations of device 500. Device 500 may also include a signal processing unit 526 configured to process incoming media content. Signal processing unit 526 may be configured, for example, to demodulate and parse encoded digital media content. In some examples, device 500 may include one or more signal processing units 526 corresponding to each of the tuners 522.

As mentioned, a user may provide an input command to system 100, access subsystem 204, and/or device 500 to request that a trick play function be executed on a media content program. For example, a media content program may be played back for experiencing by the user. While the user is experiencing the presentation of the media content, the user may want to initiate execution of a trick play function on the media content program. For instance, the user may want to skip forward in the media content program for a variety of reasons. For example, the user may want to skip over a particular segment (e.g., a commercial segment) within the media content program. Additional or alternative reasons for skipping forward or executing one or more other trick play functions on a media content program may exist that are specific to a particular user interacting with access subsystem 204.

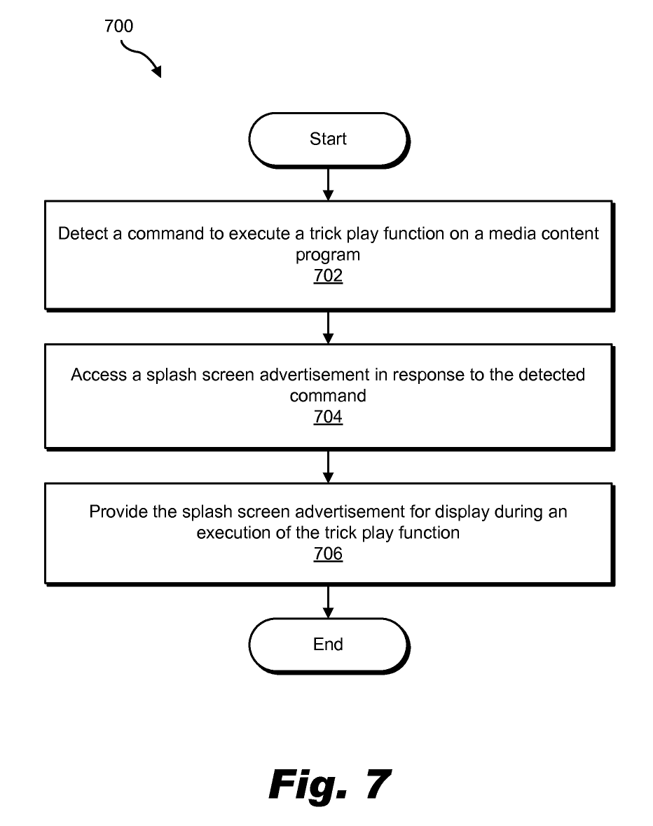

In response to a request that a trick play function be executed on a media content program, a splash screen advertisement may be accessed and provided for display during execution of the trick play function. To illustrate, FIG. 7 shows an exemplary trick play advertising method 700. While FIG. 7 illustrates exemplary steps according to one embodiment, other embodiments may omit, add to, reorder, and/or modify any of the steps shown in FIG. 7. In certain embodiments, one or more of the steps shown in FIG. 7 may be performed by one or more components of system 100, provider subsystem 202, access subsystem 204, device 500, or any combination or sub-combination thereof.

In step 702, a command to execute a trick play function on a media content program is detected. The detection may be made in any suitable way, including by detecting a user input command requesting an execution of a trick play function or by detecting a trick play command received by or issued by presentation facility 102 and/or DVR facility 104 of system 100. Typically, the command to execute the trick play function is associated with a playback of a media content program that has been buffered or otherwise recorded. For example, the command may be detected during normal, linear playback of the media content program.

In step 704, a splash screen advertisement is accessed in response to the command detected in step 702. The splash screen advertisement may be accessed in any suitable way and from any suitable source. In certain embodiments, for example, data representative of the splash screen advertisement may be embedded together with the media content program within a media content stream. Accordingly, the splash screen advertisement may be accessed in the media content stream. This may be referred to as “in-band” accessing of the splash screen advertisement.

To illustrate, a splash screen advertisement may be embedded in a media content stream such that the splash screen advertisement is delivered together with a media content program within the stream. Data representative of the splash screen advertisement may be embedded within the media content stream in any suitable way, including by embedding the splash screen advertisement within a data packet ID (“data PID”) in an MPEG media content stream. When trick play advertisement facility 106 detects a trick play command in step 702, trick play advertisement facility 106 may respond by determining whether there is a splash screen advertisement embedded within the media content stream such as by determining whether there is a data PID included in-band in the media content stream. If there is a splash screen advertisement embedded within the media content stream, the device may access the splash screen advertisement represented by the data within the data PID.

In certain embodiments, the splash screen advertisement may include a particular frame (e.g., an I-frame) within a segment of the media content program that is to be subjected to the trick play mode (e.g., a segment that is to be skipped). In other embodiments, the splash screen advertisement may be embedded together with the media content program in a media content stream but may be separate from the media content program (e.g., the splash screen advertisement may comprise an image not included in the media content program).

As another example, in certain embodiments, the splash screen advertisement may be accessed from an “out-of-band” source, which may include any source other than the media content stream including the media content program to be processed in a trick play mode. Examples of out-of-band sources of splash screen advertisements may include, without limitation, a local data store (e.g., a storage device within a media content access device), a remote data store (e.g., a storage device external to a media content access device), a server (e.g., a data server or web server), a separate media content stream (e.g., a broadcast, multicast, or narrowcast advertising content stream accessible by a media content access device), and a media channel accessible by a media content access device. To illustrate, when trick play advertisement facility 106 detects a trick play command in step 702, trick play advertisement facility 106 may respond by accessing a splash screen advertisement from an out-of-band source. In some examples, this may include accessing a locally stored splash screen advertisement that has been pre-fetched and stored within a media content access device. The device may be configured to pre-fetch one or more splash screen advertisements in any suitable way, such as by requesting and/or receiving splash screen advertisements periodically (e.g., daily) or in response to an occurrence of a predefined event (e.g., an update to the splash screen advertisements). In other examples, the splash screen advertisement may be dynamically accessed (e.g., in real time or near real time) by a media content access device from a remote source external to the device, such as from a server, in response to a detection of a trick play command in step 702.

The accessing of a splash screen advertisement in step 704 may include identifying the splash screen advertisement to be accessed. The splash screen advertisement to be accessed may be identified in any suitable way.

In certain embodiments, for example, a splash screen advertisement may be identified based on content within a media content program that is to be subjected to a trick play function. Accordingly, content (e.g., a segment within the media content program) that is to be subjected to the trick play function may be identified. This may be accomplished in any suitable way such as by identifying a playback position within the media content program when the command is detected and using the playback position and the trick play function to determine the content that is to be subjected to the trick play function. In some examples, a media content stream including the media content program may include data such as segment identifiers that may be used by trick play advertisement facility 106 to identify specific segments (e.g., commercial segments) within the media content program.

After the content that is to be a subjected to the trick play function has been identified, a splash screen advertisement that is related to the content may be identified and selected for presentation during execution of the trick play function. To illustrate, an execution of a trick play function may skip over a commercial segment within a media content program. A splash screen advertisement associated with the commercial segment may be identified and accessed. For example, a commercial segment within a media content program may include a commercial for a soft drink product. In response to a detection of a request to skip over the commercial segment, a splash screen advertisement for the soft drink product may be identified and accessed.

Identification of a splash screen advertisement that is related to content within a media content program may be accomplished in a variety of ways. In certain embodiments, for example, the splash screen advertisement may be embedded within a media content stream in a way that facilitates trick play advertisement facility 106 identifying that the splash screen advertisement is related to particular content (e.g., a commercial segment) within the media content stream. As another example, a pointer to the splash screen advertisement (e.g., a hyperlink to and/or address for accessing the splash screen advertisement) may be embedded within a media content stream in a way that enables trick play advertisement facility 106 to identify that the pointer within the media content stream is related to particular content within the media content stream and to use the pointer to access the splash screen advertisement from an out-of-band source.

As another example, in certain embodiments indexing data may be generated in advance and used to identify a segment of a media content program that is to be subjected to a trick play function and a splash screen advertisement that is related to content within a media content program. The indexing data may index content included in a media content program. For example, the indexing data may index each commercial segment in the media content program.

Indexing data may be generated in any suitable way. In certain embodiments, for example, information about commercial segments included in a media content program may be available before (e.g., 24 hours before) the media content program is made available (e.g., broadcast, multicast, or narrowcast) to a media content access device. Data representative of such information about commercial segments may be parsed to identify the commercial segments as well as their positions within a media content program. Indexing data may then be generated to include data representative of a media content program, identified commercial segments, positions of the commercial segments within the media content program, and pointers to splash screen advertisements that are related to the commercial segments. To illustrate, for a media content program scheduled to be broadcast by provider subsystem 202 during a timeslot from 1:00 PM to 2:00 PM, indexing data for the media content program may include data indicating the media content program, each commercial segment within the media content program, times associated with each commercial segment (e.g., times indicating when each commercial segment is scheduled for broadcast), and pointers to one or more splash screen advertisements for each commercial segment. Accordingly, when a trick play command is detected during playback of the media content program, trick play advertisement facility 106 may determine a playback position (e.g., a position of a play head) when the trick play command is detected and utilize the playback position and metadata associated with the media content program (e.g., a media content program identifier) to access and use indexing data for the media content program. For example, an indexing data table or other data structure may be searched using metadata to locate information for the media content program. The playback position may then be used to identify specific content (e.g., a segment) within the media content program that will be subjected to the trick play function. For example, trick play advertisement facility 106 may identify a commercial segment within the media content program that will be skipped over by the trick play function. Trick play advertisement facility 106 may further use the indexing data to identify and access a splash screen advertisement that is related to the commercial segment. In this or a similar manner, indexing data may be used to identify a splash screen advertisement that is related to content to be subjected to a trick play mode, without having to embed information and/or splash screen advertisement data within a media content stream.

Indexing data may be accessed locally or remotely by a media content access device. In certain embodiments, for example, indexing data may be pre-fetched by a media content access device periodically (e.g., every 24 hours) or in response to a predefined event. In other embodiments, the media content access device may dynamically access indexing data maintained at a remote source in response to a detection of a trick play command.

In addition or alternative to identifying a splash screen advertisement based on relatedness of the splash screen advertisement to content within a media content program, one or more other factors may be used to identify a splash screen advertisement to be accessed for display during execution of a trick play function. Accordingly, in certain examples, a splash screen advertisement may be identified based on its relatedness to content within a media content program. In other examples, a splash screen advertisement may be identified without consideration of its relatedness to content within a media content program. In yet other examples, a splash screen advertisement may be identified based on a combination of relatedness and other factors.

As an example, a splash screen advertisement may be identified based on information specified in a user profile. Examples of such information may include user preferences indicating types of content typically experienced by a user and/or other preferences of a user. As described in more detail further below, in certain embodiments, a user may pre-configure one or more user preferences and/or trick play advertising settings to be used to identify one or more splash screen advertisements to be accessed for display during execution of a trick play mode.

As another example, a splash screen advertisement may be identified based on purchases of ad placements by advertisers. For example, advertisers may purchase placements of splash screen advertisements during execution of trick play functions. In certain embodiments, the purchases may be in the form of high bids for placements of splash screen advertisements during execution of trick play functions.

Any combination or sub-combination of the above-mentioned conditions and/or other suitable conditions may be used to identify one or more splash screen advertisements to be displayed during execution of a trick play function. In certain embodiments, trick play advertisement facility 106 may maintain and/or operate in accordance with an advertisement selection heuristic specifying one or more conditions, including any of the conditions described above, to be considered to identify a splash screen advertisement to be accessed and displayed.

The trick play function associated with the command received in step 702 may be executed in any of the ways described herein. For example, presentation facility 102 and/or DVR facility 104 of system 100 may perform the execution of the trick play function. In some examples, execution of the trick play command may include interrupting a normal playback of the media content program and traversing a segment of the media content program at a faster rate than a normal playback rate.

After a splash screen advertisement is accessed in step 704 in any of the ways described above, method 700 may continue at step 706. In step 706, the splash screen advertisement accessed in step 704 is provided for display during execution of the trick play function. Accordingly, instead of viewing a graphical view is it would traditionally be displayed during execution of a trick play mode, a user may view the splash screen advertisement during the execution of the trick play function. The splash screen advertisement may be displayed in any way suitable for viewing by a user. For example, the splash screen advertisement may be displayed in a full-screen format or a partial screen format during execution of the trick play function.

Display of the splash screen advertisement is typically of brief duration (e.g., approximately one second). The brief duration of display may help prevent a user from experiencing burdensome or annoying delay associated with execution of a trick play function. As mentioned, the brief display of the splash screen advertisement may be designed to attract the attention of a user during execution of a trick play function. Hence, the user may be able to quickly determine from the splash screen display whether a product or service advertised by the splash screen display is of interest to the user. If so, the user may request and/or access additional information about the product or service advertised by the splash screen advertisement. To this end, system 100 may provide one or more tools configured to facilitate user access to additional information about a product or service advertised by a splash screen advertisement. For example, the user may initiate a rewind or skip backward trick play mode to access and view a commercial segment that is related to the splash screen advertisement. As another example, the splash screen advertisement may include information and/or a pointer helpful for accessing additional information. For instance, the splash screen advertisement may include a user selectable option for accessing additional information, such as a link to additional information such as a long-form advertisement (e.g., click here to watch a video-on-demand clip about a product or service). In response to a user selection of the option, system 100 may automatically access and provide additional information about a product or service. In some examples, this may include accessing and displaying a website and/or a video-on-demand clip for viewing and/or access by the user.

In certain embodiments, trick play advertisement facility 106 may generate a user interface configured to facilitate user access to additional information about a product or service advertised by a splash screen advertisement. Trick play advertisement facility 106 may provide data representative of the user interface to user interface facility 108, which may provide the user interface for experiencing and use by a user. For example, the user interface may include a GUI with one or more selectable links to additional information about a product or service advertisement by one or more splash screen advertisements. In some examples, the links may be mapped to one or more commercial segments within a media content program, and may be arranged to provide a form of “chaptering” data for commercial segments within a media content program. The user may select a link to gain access to a commercial segment. Trick play advertisement facility 106 may respond to a user selection of a link by moving a play head to a start of the commercial segment and initiating playback of the commercial segment. In some examples, such a GUI may be presented in response to user input requesting presentation of the GUI or automatically after a trick play function has been executed. Accordingly, when a user views a splash screen advertisement during execution of a trick play mode and determines that a product or service advertised by the splash screen advertisement is of interest, the user may utilize a user interface to select a link to gain access to additional information about the product or service.

One or more of the steps shown in FIG. 7 may be repeated. For example, steps 702-706 may be repeated for a request to execute another trick play function. As another example, steps 704 and 706 may be repeated if multiple splash screen advertisements are to be displayed during execution of a trick play function.

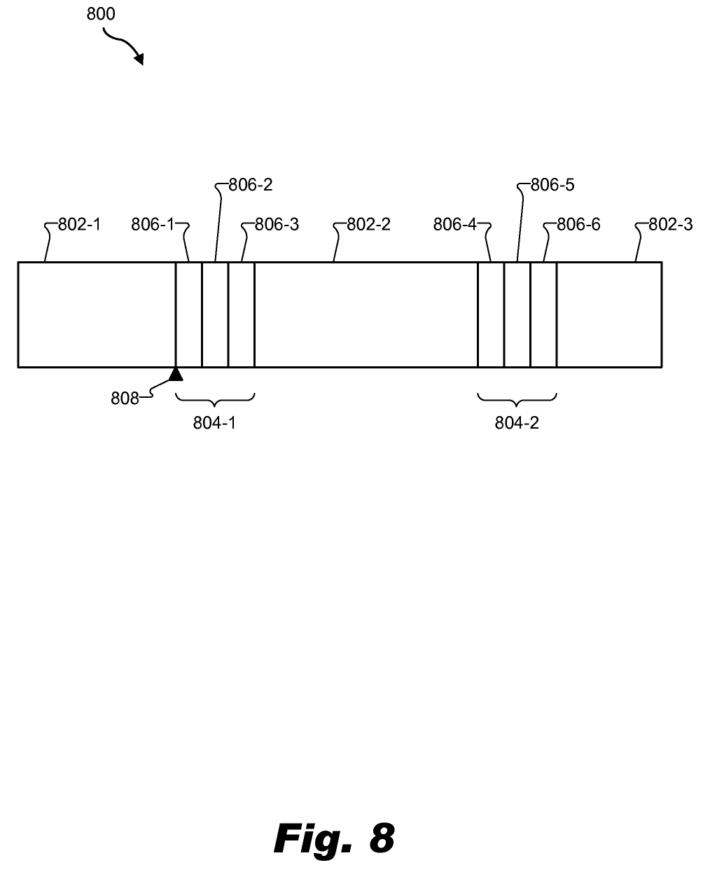

Several examples of trick play advertising will now be described in a context of a particular media content program being played back by a set-top box. FIG. 8 illustrates a representation 800 of an exemplary media content program. As shown in FIG. 8, the media content program may include program content segments 802 (e.g., program content segments 802-1 through 802-3) with commercial breaks 804 (e.g., commercial breaks 804-1 and 804-2) inserted between the program content segments 802. Each commercial break 804 may include one or more commercials (i.e., commercial segments). In FIG. 8, commercial break 804-1 includes three commercial segments 806-1 through 806-3, and commercial break 804-2 includes another three commercial segments 806-4 through 806-6.

The set-top box may play back the media content program represented in FIG. 8 for experiencing by a user. The playback may progress linearly from a start position of the media content program to an end of the first program content segment 802-1, which position is depicted in FIG. 8 by a play head 808 indicating a current playback position. During normal, linear playback of the media content program, playback may continue sequentially from the end of program content segment 802-1 to a start of a first commercial segment 806-1. However, the user may want to skip over one or more commercial segments 806. To this end, when the current playback position is at the start of commercial segment 806-1, the user may provide an input command configured to initiate a skip forward trick play function. For example, the user may select the skip forward button 626 on remote control device 600. The set-top box may detect the input command and interrupt normal, linear playback of the media content program by initiating a trick play function to skip forward a predefined length of time within the media content program. For example, the predefined length of time may be approximately thirty seconds, and the set-top box may initiate a skip forward trick play function to skip play head 808 forward approximately thirty seconds from the position of play head 808 when the input command is detected.

During execution of the skip forward trick play function, the set-top box may provide a splash screen advertisement for display. The splash screen advertisement may be identified and accessed for display in any of the ways described above. As an example, commercial segment 806-1 may be approximately thirty seconds in length, and the skip forward trick play function may skip over commercial segment 806-1. A splash screen advertisement related to commercial segment 806-1 may be identified and accessed for display during the execution of the skip forward trick play function in any of the ways described above.

If the user provides another input command configured to initiate another skip forward trick play function, the set-top box may initiate another skip forward trick play function to skip play head 808 forward approximately another thirty seconds. If commercial segment 806-2 is approximately thirty seconds in length, execution of the skip forward trick play function may skip over commercial segment 806-2. A splash screen advertisement related to commercial segment 806-2 may be identified and accessed for display during the execution of the skip forward trick play function in any of the ways described above. In this or a similar manner, splash screen advertisements may be displayed sequentially when multiple trick play functions are sequentially executed.

In certain examples, one or more splash screen advertisements may be displayed during execution of a trick play function. For example, each of the commercial segments 806 shown in FIG. 8 may be approximately fifteen seconds in length. Accordingly, a skip forward trick play function that skips ahead approximately thirty seconds from the position indicated by play head 808 in FIG. 8 may skip over commercial segments 806-1 and 806-2. When a skip forward function skips over multiple commercial segments, one or more splash screen advertisements may be displayed. In certain embodiments, for example, a splash screen advertisement may be identified, accessed, and displayed for each of the commercial segments 806-1 and 806-2 skipped over by the trick play function. For example, a splash screen advertisement related to commercial segment 806-1 may be briefly displayed followed by a brief display of a splash screen advertisement that is related to commercial segment 806-2. To illustrate, commercial segment 806-1 may advertise a soft drink product, and commercial segment 806-2 may advertise an automobile dealership. When a skip forward trick play function skips over commercial segments 806-1 and 806-2, a splash screen advertisement advertising the soft drink product may be displayed first followed a splash screen advertisement advertising the automobile dealership. Accordingly, the user may be able to ascertain an order of skipped over commercial segments 806-1 and 806-2 based on the ordered display of splash screen advertisements and be able to rewind or skip backward to view one or more of the commercial segments 806-1 and 806-2 if interested.

In certain embodiments, the number of splash screen advertisements displayed during an execution of a trick play function may be limited to a predefined maximum number. For example, a limitation of a single splash screen advertisement for each execution of trick play function may be in place. Accordingly, when the skip forward trick play function skips over multiple commercial segments 806-1 and 806-2, a single splash screen advertisement may be identified for display based on one or more selection conditions specified in an advertisement selection heuristic. In certain embodiments, a splash screen advertisement related to a sequentially first commercial segment 806-1 being skipped over may be identified and selected for display. In other embodiments, the selection may be made based on a highest bid for placement of splash screen advertisements and/or one or more other factors.

While the examples described in reference to FIG. 8 have been described in a context of a set-top box executing a skip forward trick play function on a particular media content program, this is illustrative only. Trick play advertising may be similarly performed by other devices, for other media content programs, and/or for other trick play functions (e.g., skip backward, fast-forward, and rewind) in other embodiments.

In certain embodiments, one or more user preferences and/or settings for trick play advertising may be user configurable. To this end, trick play advertisement facility 106 may provide one or more tools configured to facilitate a user configuration of one or more user preferences and/or settings to be used in trick play advertising. The tools may be included in a user interface such as a GUI that a user may access and utilize to define one or more trick play advertising settings and/or user preferences for use by trick play advertisement facility 106. Examples of user configurable trick play advertising settings and/or preferences may include, but are not limited to, one or more conditions to be used to identify a splash screen advertisement (e.g., user preferences for a particular type of advertisement, product, or service), an opt-in setting for opting in to allow splash screen advertisement to be displayed, an opt-out setting for opting out to prevent splash screen advertisements to be displayed, a number of splash screen advertisements to be displayed for each execution of a trick play function (e.g., a number of splash screen advertisement per skip forward trick play function), a length of time to be skipped by a skip forward trick play function, and a length of time to be skipped by a skip backward trick play function. Accordingly, a user may configure one or more trick play advertising settings and/or user preferences as may suit the user. To illustrate, a user may select an option to opt in to having splash screen advertisements displayed during execution of trick play functions. In some examples, a service provider may provide one or more incentives to a user for opting in to trick play advertising, such as a subscription discount and/or access to additional services, content, and/or features.

The user may further specify one or more user preferences to be used to identify splash screen advertisements for display. For example, the user may select one or more options to specify a product, service, brand, type of advertisement, etc. for which splash screen advertisements may be displayed or banned from display.

The user may further specify a length of a skip when a skip forward trick play function is executed as well as a number of splash screen advertisements that may be displayed during execution of a skip forward trick play function. For example, the user may set the length of the skip to a thirty second length of time and a maximum number of splash screen advertisements that may be displayed during the execution of the skip forward trick play function to a single splash screen advertisement.

Accordingly, the user may be allowed to have at least some control over the splash screen advertisements that are displayed. This may help users customize trick play advertising, which may make users more willing to opt in to and utilize trick play advertising, which in turn may make trick play advertising more appealing and valuable to advertisers.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
detecting, by a media content access system, a command to execute a trick play function on a media content program;
accessing, by the media content access system, a splash screen advertisement in response to the detected command; and
providing, by the media content access system, the splash screen advertisement for display during an execution of the trick play function.

2. The method of claim 1, further comprising:
performing, by the media content access system, the execution of the trick play function by interrupting a normal playback of the media content program and traversing a segment of the media content program at a faster rate than a normal playback rate.

3. The method of claim 1, wherein the trick play function comprises a skip function configured to skip a playback position forward or backward a predetermined length of time within the media content program.

4. The method of claim 1, wherein the accessing comprises:
identifying a segment of the media content program to be subjected to the trick play function; and
identifying the splash screen advertisement as related to the segment of the media content program.

5. The method of claim 4, wherein:
the segment of the media content program comprises a commercial segment configured to advertise a product or service; and
the splash screen advertisement is configured to advertise the product or service.

6. The method of claim 1, wherein:
the media content program is included within a media content stream;
the media content stream further includes data representative of the splash screen advertisement; and
the accessing of the splash screen advertisement comprises
identifying a segment of the media content program to be subjected to the trick play function,
identifying the splash screen advertisement as related to the segment, and
accessing the splash screen advertisement within the media content stream.

7. The method of claim 1, wherein the accessing of the splash screen advertisement comprises using indexing data to identify a segment of the media content program to be subjected to the trick play function and the splash screen advertisement as related to the segment.

8. The method of claim 1, wherein the accessing of the splash screen advertisement comprises:
identifying a segment of the media content program to be subjected to the trick play function by searching indexing data based on metadata associated with the media content program and a playback position associated with a playback of the media content program; and
using the indexing data to identify the splash screen advertisement based on the identified segment of the media content program.

9. The method of claim 1, wherein the accessing of the splash screen advertisement comprises accessing data representative of the splash screen advertisement from an out-of-band source.

10. The method of claim 1, wherein the accessing of the splash screen advertisement comprises one of:
accessing data representative of the splash screen advertisement from a remote data storage in real time in response to the detected command; and
accessing pre-fetched data representative of the splash screen advertisement from a local data storage.

11. The method of claim 1, wherein the accessing of the splash screen advertisement comprises identifying the splash screen advertisement based on at least one of a user preference and a setting preconfigured by the user and specified in a user profile associated with the user.

12. The method of claim 1, wherein the accessing of the splash screen advertisement comprises identifying the splash screen advertisement based on a purchased placement of the splash screen advertisement.

13. The method of claim 1, further comprising providing, by the media content access system, at least one tool configured to facilitate a user accessing additional information about a product or service advertised by the splash screen advertisement; and
wherein the additional information comprises at least one of a commercial segment within the media content program, a website, and a video-on-demand clip.

14. The method of claim 1, further comprising providing, by the media content access system, a user interface configured to facilitate a configuration by a user of the media content access system of at least one setting to be used in at least one of the accessing and the presenting of the splash screen advertisement.

15. The method of claim 1, embodied as computer-executable instructions on at least one tangible computer-readable medium.

16. A method comprising:
playing back, by a media content access system, a media content program for experiencing by a user;
executing, by the media content access system, a trick play function on the media content program; and
providing, by the media content access system, at least one splash screen advertisement for display during the execution of the trick play function.

17. The method of claim 16, wherein the executing comprises:
interrupting the playback of the media content program; and
traversing at least one segment of the media content program at a faster rate than a normal playback rate.

18. The method of claim 16, wherein:
the trick play function comprises a skip forward function configured to skip a playback position forward a predetermined length of time within the media content program;
the executing of the trick play function comprises skipping one or more commercial segments within the media content program; and
the providing of the at least one splash screen advertisement for display comprises providing a splash screen advertisement for display for each of the one or more commercial segments.

19. A system comprising:
a digital video recording facility configured to execute a trick play function in association with a playback of a media content program; and
a trick play advertisement facility communicatively coupled to the digital video recording facility and configured to
detect a command to execute the trick play function on the media content program;
access a splash screen advertisement in response to the detected command; and
provide the splash screen advertisement for display during an execution of the trick play function.

20. The system of claim 19, wherein the digital video recording facility is configured to execute the trick play function by interrupting the playback of the media content program and traversing a segment of the media content program at a faster rate than a normal playback rate.

21. The method of claim 19, wherein the trick play function comprises a skip function configured to skip a playback position forward or backward a predetermined length of time within the media content program.

22. The system of claim 19, implemented by at least one of a set-top box, a television, and a digital video recorder device.

23. The system of claim 19, wherein the media content program comprises a recorded live transmission of a broadcast television program as recorded by the digital video recording facility.
